(19) United States
(12) Patent Application Publication
(10) Pub. No.: US 2007/0060072 A1
(43) Pub. Date: Mar. 15, 2007

(54) Portable electronic device

(76) Inventors: Cheng-Hsin Sung, Taipei (TW); Kun-Ming Chen, Taipei (TW)

Correspondence Address: RABIN & Berdo, PC, 1101 14TH STREET, NW, SUITE 500, WASHINGTON, DC, 20005, US

(21) Appl. No.: 11/327,442

(22) Filed: Jan. 9, 2006

(30) Foreign Application Priority Data
Sep. 14, 2005 (TW) 094131725

(51) Int. Cl. H04B 1/38; H04M 1/00

(52) U.S. Cl. 455/90.3; 455/575.3

(57) ABSTRACT

A portable electronic device includes a body and a signal transmitter/receiver. The body has a display having a first display mode and a second display mode. The signal transmitter/receiver is pivotally connected to the body through the first pivot and the second pivot. The transmitter/receiver may be rotated to a first signal receiving position or a second signal receiving position corresponding to the first display mode or the second display mode. Therefore, signals can be better transmitted or received when the display is in a given display mode.

### CROSS-REFERENCE TO RELATED APPLICATIONS

This non-provisional application claims priority under 35 U.S.C. § 119(a) on Patent Application No(s). 094131725 filed in Taiwan, R.O.C. on Sep. 14, 2005, the entire contents of which are hereby incorporated by reference.

### BACKGROUND OF THE INVENTION

1. Field of Invention

The present invention relates to a portable electronic device, and more particularly, to a portable electronic device having a signal transmitter/receiver to receive or transmit wireless signals.

2. Description of Related Art

Portable electronic devices such as mobile phones, personal digital assistants (PDA) or hand-held personal computers, pocket personal computers, are easy to carry and enable users to search, save, or process information. Moreover, they may be used as multimedia for playing games, showing images or films, or playing music. Such portable electric devices have recently become the most popular electronic products. However, they still have not met the demand of consumers. Therefore, global positioning system (GPS) navigators that enable users to receive geographic information at anytime and anywhere have received increasing attention from consumers. Examples of GPS navigators include the products of, eTrex Legend, iQue® M5 Quest™ 2 produced by Garmin International Ltd (PI://3w.garmin.com/). The GPS navigator has a display and digital geographic maps embedded therein. The antenna of the GPS navigator receives low-power, ultra high frequency (UHF) wireless electronic signals from 24 satellites and five ground stations to thereby obtain positional information. With such information and its embedded digital maps, the GPS navigator can utilize its trip planning function to thereby obtain accurate positional information and directional information.

The display of the GPS navigator has two display modes: vertical and horizontal. For instance, the iQue® M5 produced by Garmin International Ltd. has a vertical-mode display, and Quest™ 2 has a horizontal-mode display. Vertical-mode GPS navigators may be easy to be held in hand, and horizontal-mode GPS navigators are more convenient for viewing broad scale of electronic maps. In order to provide more options for consumers, some manufacturers have introduced GPS navigators having displays that may change their display mode based on the position of the navigators. That is, when a GPS navigator is used in a vertical position, its display will be in the vertical mode, and when the GPS navigator is used in a horizontal position, its display mode will be switched to the horizontal mode. When a user holds a GPS navigator while walking, the display of the GPS navigator may be set to the vertical mode. When a user is driving, the display of the GPS navigator may be set to the horizontal mode to display broad scale of electronic maps.

The switchable display mode of GPS navigators have made the GPS navigators easier to use. However, when a user changes the position of the GPS navigator, the change may affect the transmission and reception of signals of the antenna of the GPS navigator. Taking the products of Garmin International Ltd., iQue® M5 and Quest™ 2, as an example, both the products have an antenna connected to the body of the GPS navigator through a one-way pivot, so that the antenna can be received at the back of the body of the GPS navigator or can be rotated up to receive or transmit signals. However, if such a design is applied to GPS navigators with a switchable display mode, although the antenna could still be rotated up, the antenna's position after being rotated up will only match one type of display mode. For example, if the antenna is designed for a vertical display mode, when horizontal display mode is taken, the antenna cannot be totally rotated outward to sky to receive satellite signals. This problem may be solved by adopting a two-way hinge structure as is used in flip cell phones. However, in the two-way hinge structure, only one pivot is located at one end of the body of a GPS navigator. If the antenna is set to a position in light of the vertical display mode, then it may not be rotated outside the body of the GPS navigator totally when the navigator is in the horizontal mode.

### SUMMARY OF THE INVENTION

As described above, GPS navigators having a display mode switchable according to the position of the navigators may make it more convenient for users to view the display when the navigators are operated in different ways. However, at present, the design of GPS navigators with a switchable display mode has not taken into account the relationship between antenna position and display mode. If the antenna is positioned in light of the vertical display mode, then it may not be able to receive and transmit signals well when the navigator is in the horizontal display mode. If the antenna is positioned in light of the horizontal display mode, then it may not be able to receive and transmit signals well when the navigator is in the vertical display mode. In order to solve the problem, the present invention provides a portable electronic device having a signal transmitter/receiver whose position may be changed according to the way in which the portable electronic device is operated.

A portable electronic device according to an exemplary embodiment of the present invention includes a body, a first pivot, a second pivot, and a signal transmitter/receiver, wherein a housing is formed on one end of the back of the body, and a joint is formed at one corner of the housing. The first pivot is pivotally connected to the joint and has a first rotation axis. The second pivot is pivotally connected to one end of the first pivot and has a second rotation axis. The signal transmitter/receiver is fixed to the second pivot. As such, the signal transmitter/receiver may be rotated around the first rotation axis or the second rotation axis corresponding the body so that the signal transmitter/receiver will be in an accommodating position when it is received in the housing, in a first signal receiving position when it is rotated outward around the first pivot, or in a second signal receiving position when it is rotated outward around the second pivot. In both the first signal receiving position and the second signal receiving position, the signal transmitter/receiver will be located at the very end of the body of the navigator and point upward to the sky.

Therefore, the position of the transmitter/receiver may be adjusted for better signal transmitting or receiving according to the position of the body of the navigator.

The portable electronic device according to the exemplary embodiment of the present invention includes the first pivot connected to one end of the housing and the second pivot connected to one end of the first pivot, while in the second signal receiving position, the signal transmitter/receiver may still be rotated outside totally and be located at the very end of the body of the navigator, and point upward to the sky. Therefore, in both the first signal receiving position and the second signal receiving position, the signal transmitter/receiver may be adjusted to better transmit or receive signals according to the way the navigator is operated.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is an exploded perspective view of a portable electronic device according to an exemplary embodiment of the present invention.

FIG. 2 is another exploded perspective view of the portable electronic device according to an exemplary embodiment of the present invention.

FIGS. 3A, 3B, 3C, 3D, and 3E illustrate the operation of the portable electronic device according to an exemplary embodiment of the present invention.

### DETAILED DESCRIPTION OF THE INVENTION

The portable electronic devices of the present invention may be mobile phones, personal digital assistants (PDA), PDA phones, Smart phones, pocket PC's, hand-held PC's, and portable GPS devices. In the detailed illustration of the present invention below, a GPS navigator is used as an example.

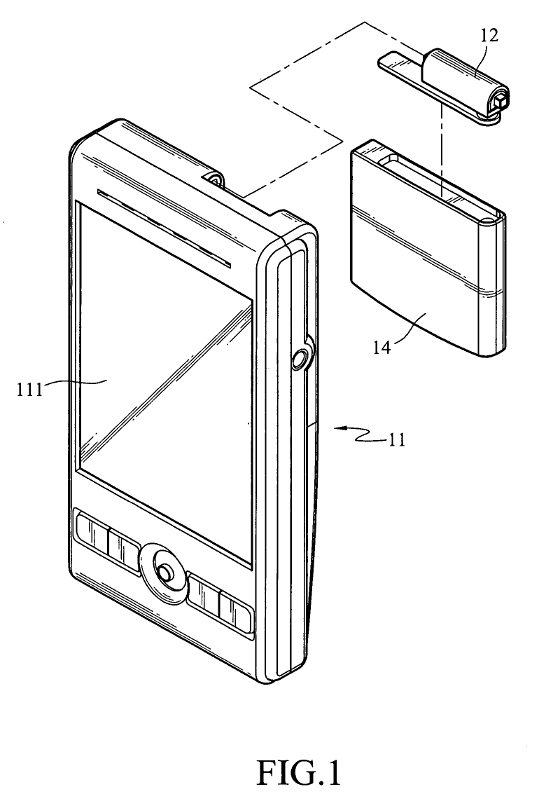

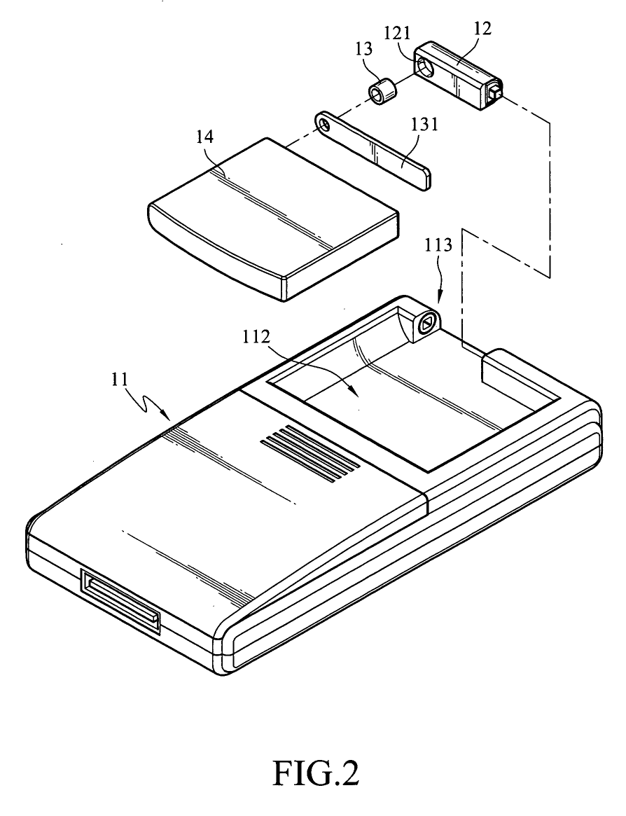

As shown in FIGS. 1, 2, and 3A, a portable electronic device according to exemplary embodiments of the present invention includes a body 11, a first pivot 12, a second pivot 13, and a signal receiver/transmitter 14. The body 11 is of a rectangular shape, and includes electronic elements that process electronic data (not shown in the drawings). There is a display 111 located on the front of the body 11 and a concave housing 112 formed on one end of the back of the body 11. A joint 113 is formed on a corner of the housing 112 adjacent to the end of the body 11.

The first pivot 12 is pivotally connected to the joint 113, and thus a first rotation axis X is defined. There is a pivot hole 121 formed on one end of the first pivot 12. The second pivot 13 is pivotally connected to the pivot hole 121 of the first pivot 12, and thus a second rotation axis Y is defined. The first rotation axis X is perpendicular to the second rotation axis Y at the corner of the body 11. In addition, a retaining plate 131 is formed on the second pivot 13.

The signal transmitter/receiver 14 is an antenna and is of a rectangular shape. The volume of the signal transmitter/receiver 14 is little smaller than that of the housing 112 so that the signal transmitter/receiver 14 can be received in the housing 112. The signal transmitter/receiver 14 is further retained on the retaining plate 131 of the second pivot 13, so that the signal transmitter/receiver 14 may be rotated around the first rotation axis X of the first pivot 12 or around the second rotation axis Y of the second pivot 13.

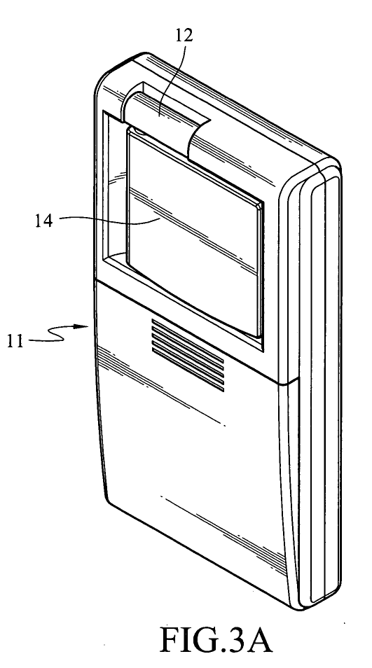

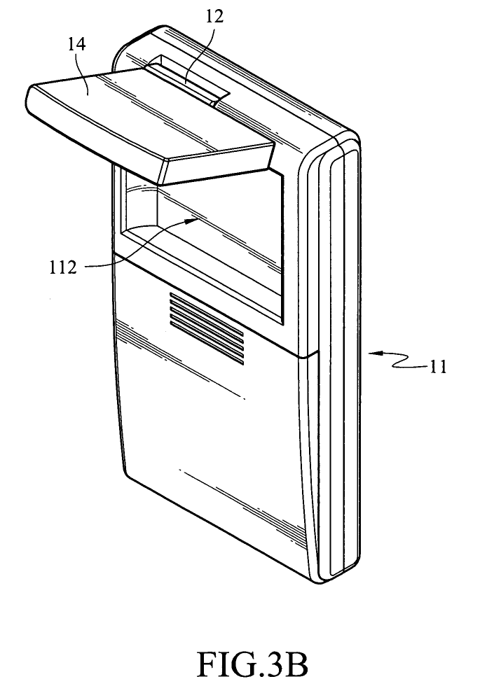

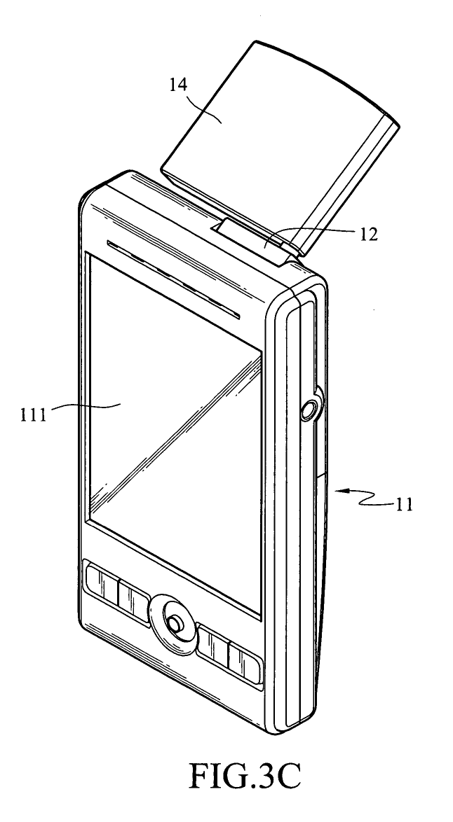

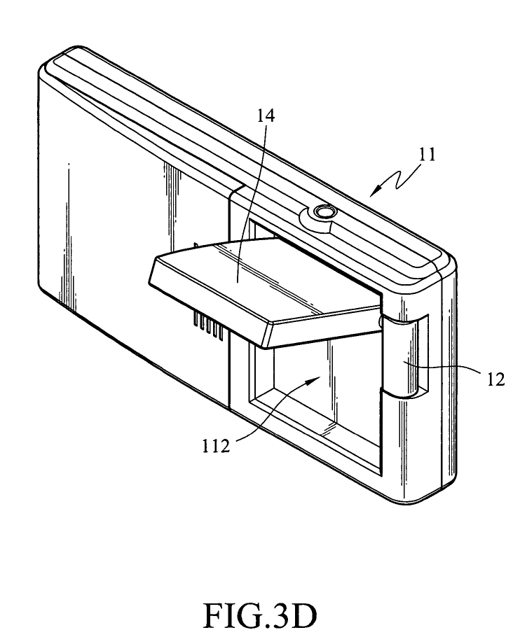

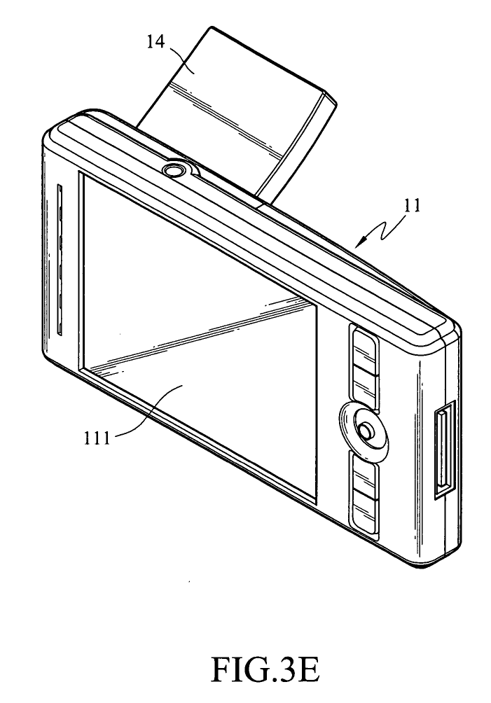

As shown in FIGS. 3A, 3B, 3C, 3D, and 3E, in the portable electric device according to an exemplary embodiment of the present invention, the first pivot 12 and the second pivot 13 define the first rotation axis X and the second rotation axis Y at the end of the body 11. When not used, the signal transmitter/receiver 14 is received in the housing 112, the position of which is defined as the accommodating position of the signal transmitter/receiver. When a user operates the portable electric device in a vertical direction, the display 111 is in a first vertical display mode corresponding to the way of operation. When a user uses the electronic maps embedded in the portable electric device (GPS) for positioning, the signal transmitter/receiver 14 may be rotated outward around the first rotation axis X, and the transmitter/receiver 14 may point up to the sky without any obstacles, the position of which is defined as the first signal receiving position. In this position, the navigator will be able to carry out the positioning function as long as data received from more than three satellites are available.

When a user operates the portable electric device in a vertical direction, the display 111 is in a second horizontal display mode corresponding to the way of operation. When a user uses the electronic maps embedded in the portable electric device (GPS) for positioning, the signal transmitter/receiver 14 may be rotated outward around the second rotation axis Y, and the transmitter/receiver 14 may point up to the sky without any obstacles, the position of which is defined as the second signal receiving position. In this position, the navigator will be able to carry out the positioning function as long as data received from more than three satellites are available.

Whether in a first signal receiving position or a second signal receiving position, the signal transmitter/receiver 14 will be located at the very end of the body 11 and point upward to the sky. Therefore, the position of the transmitter/receiver may be adjusted to better transmit or receive signals according to the position of the body 11.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A portable electronic device, comprising:
a body having a plurality of electronic elements, a display formed on a first surface of the body, a housing formed on a second surface of the body, wherein the body is operated in a vertical direction or a horizontal direction, and the display has a first display mode and a second display mode correspondingly;
a first pivot pivotally connected to an end of the housing;
a second pivot pivotally connected to an end of the first pivot; and
a signal transmitter/receiver, connected to the second pivot and being rotated with respect to the body by means of the first pivot and the second pivot respectively so that the signal transmitter/receiver stays at a position, wherein the position comprises at least an accommodating position when the signal transmitter/receiver is received in the housing, a first signal receiving position when the transmitter/receiver is rotated outward around the first pivot corresponding to the first display mode, and a second signal receiving position when the transmitter/receiver is rotated outward around the second pivot corresponding to the second display mode.

2. The portable electronic device of claim 1, wherein a joint is formed at one end of the housing and the first pivot is pivotally connected to the joint.

3. The portable electronic device of claim 1, wherein a pivot hole is formed at one end of the first pivot, and the second pivot is pivotally connected to the pivot hole.

4. The portable electronic device of claim 1, wherein a retaining plate is formed on the second pivot and the signal transmitter/receiver is fixed to the retaining plate.

5. The portable electronic device of claim 1, wherein the transmitter/receiver is an antenna.
